(19) United States
(12) Patent Application Publication
(10) Pub. No.: US 2026/0016972 A1
(43) Pub. Date: Jan. 15, 2026

(54) POWER BASED DISTRIBUTION OF MEMORY OPERATIONS

(71) Applicant: Micron Technology, Inc., Boise, ID (US)

(72) Inventor: Daniel J. Hubbard, Boise, ID (US)

(21) Appl. No.: 19/254,791

(22) Filed: Jun. 30, 2025

Related U.S. Application Data
(60) Provisional application No. 63/669,015, filed on Jul. 9, 2024.

(51) Int. Cl. G06F 3/06

(52) U.S. Cl. CPC G06F 3/0625; G06F 3/0635; G06F 3/0659; G06F 3/0679

(57) ABSTRACT

The present disclosure configures a system component, such as a memory sub-system controller, to provide adaptive power management. The controller receives one or more requests to perform a plurality of memory operations associated with data stored in a set of memory components. The controller, in response to receiving the one or more requests, accesses power management information associated with the set of memory components. The controller determines, based on the power management information, a maximum number of memory components, in each group of a plurality of groups of the set of memory components, that are configured to be simultaneously enabled for performing one or more memory operations. The controller distributes the plurality of memory operations across the plurality of groups based on the maximum number of memory components that are configured to be simultaneously enabled for performing the one or more memory operations.

### PRIORITY APPLICATION

This application claims the benefit of priority to U.S. Provisional Application Ser. No. 63/669,015, filed Jul. 9, 2024, which is incorporated herein by reference in its entirety.

### TECHNICAL FIELD

Examples of the disclosure relate generally to memory sub-systems and, more specifically, to managing power associated with performing memory operations across a set of memory components, such as memory dies or memory blocks.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIG. 2 is a block diagram of an example media operations manager, in accordance with some examples.

FIGS. 3-4 are block diagrams of an example memory sub-system, in accordance with some examples.

FIG. 5 is a flow diagram of an example method to perform media operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

The present disclosure configures a system component, such as a memory sub-system controller, to dynamically perform memory operations in a way that optimally balances power distribution. The memory sub-system controller can access power management information associated with a set of memory components (e.g., memory dies, memory back-end channels, and/or memory die stacks) which can specify the maximum number of memory components, in each group of a plurality of groups that can be active (e.g., performing memory operations) at a given time. Based on this information, the controller can distribute a plurality of memory operations (e.g., a set of sequential write operations) across the plurality of groups to maximize the number of memory components that are active without violating the power conditions. Namely, the controller can activate a first subset of memory components in a first group up to the maximum number allowable to be active in the first group and can then (or in parallel) activate a second subset of memory components in a second group up to the maximum number allowable to be active in the second group. This improves the overall efficiency of operating the memory sub-system by allowing more memory operations to be performed simultaneously across multiple memory die stacks and/or back-end channels.

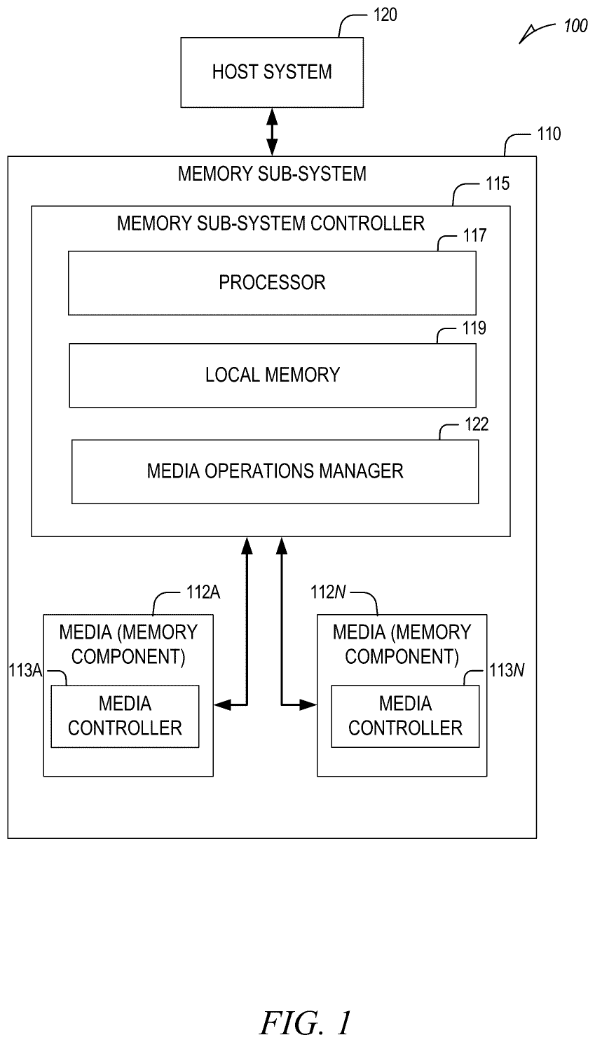

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data” and can be performed periodically for each block stripe (BS) that is stored in the memory sub-system. “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management (e.g., read disturb scan operations), different near miss error correction code (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NOR- and (NAND) devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

In the rapidly evolving field of SSD technology, the push towards higher density NAND packages, such as 32 Die Packages (32DP+), represents a significant advancement aimed at meeting the growing demand for high-capacity storage solutions. However, this technological progression brings forth complex challenges, particularly in balancing power requirements with performance optimization. NAND packages are conventionally designed without a comprehensive consideration of power constraints in relation to a write translation sequence or other memory operations. This lack of consideration becomes particularly problematic in the context of high-density packages, such as the 32DP package, which consists of two stacks of 16 memory die each. In this configuration, only 8 dies within each 16-die stack could be active simultaneously. This restriction inherently caps the performance potential of the SSD, as the inactive dies during certain operations lead to underutilization of available resources, thereby creating inefficiencies and waste.

Conventional memory controllers do not incorporate NAND package power requirements into the determination of Write Translation sequences or other memory operations and requests. This disconnect not only leads to suboptimal performance but also results in increased power consumption and reduced efficiency, as the SSD may not utilize its full potential due to power-related constraints.

The present disclosure addresses the above and other deficiencies by providing a memory controller that can optimally balance power distribution across different memory stacks and/or memory back-end channels. The memory controller can access power management information associated with a set of memory components (e.g., memory dies, memory back-end channels, and/or memory die stacks) which can specify the maximum number of memory components, in each group of a plurality of groups that can be active (e.g., performing memory operations) at a given time. Based on this information, the controller can distribute a plurality of memory operations (e.g., a set of sequential write operations) across the plurality of groups to maximize the number of memory components that are active without violating the power conditions. This improves the overall efficiency of operating the memory sub-system by allowing more memory operations to be performed in simultaneously across multiple memory die stacks and/or back-end channels.

For some examples, the memory sub-system (e.g., memory sub-system controller) can receive one or more requests to perform a plurality of memory operations associated with data stored in the set of memory components. The controller, in response to receiving the one or more requests, accesses power management information associated with the set of memory components. The controller determines, based on the power management information, a maximum number of memory components, in each group of a plurality of groups of the set of memory components, that are configured to be simultaneously enabled for performing one or more memory operations and distributes the plurality of memory operations across the plurality of groups based on the maximum number of memory components that are configured to be simultaneously enabled for performing the one or more memory operations.

In some examples, the plurality of memory operations includes at least one of one or more requests to program data or one or more requests to read data. In some cases, the set of memory components are part of a memory sub-system. The memory sub-system can include one or more front-end channels and a plurality of back-end channels. The one or more front-end channels can be configured to receive the one or more requests from a host system and the plurality of back-end channels can be configured to route commands generated based on the one or more requests to the set of memory components. In some examples, a first group of the plurality of groups of the set of memory components includes a first plurality of memory dies coupled to a first channel of the plurality of back-end channels and a second group of the plurality of groups of the set of memory components includes a second plurality of memory dies coupled to a second channel of the plurality of back-end channels.

The controller, based on the power management information, can route a first portion of the plurality of memory operations to a first portion of the first plurality of memory dies. The controller can determine that a number of memory dies in the first portion of the first plurality of memory dies corresponds to the maximum number of memory components and, in response, can route a second portion of the plurality of memory operations to a second portion of the second plurality of memory dies. The controller, based on the power management information, can interleave routing a first portion of the plurality of memory operations to a first portion of the first plurality of memory dies with routing a second portion of the plurality of memory operations to a second portion of the second plurality of memory dies.

The first plurality of memory dies can be part of a first stack of memory dies and the second plurality of memory dies can be part of a second stack of memory dies. The controller can determine that a number of memory dies in the first portion of the first plurality of memory dies corresponds to the maximum number of memory components and that a number of memory dies in the second portion of the second plurality of memory dies corresponds to the maximum number of memory components. In such cases, before routing additional memory operations to the set of memory components, the controller can, in response to determining that the number of memory dies in the first portion of the first plurality of memory dies corresponds to the maximum number of memory components and that the number of memory dies in the second portion of the second plurality of memory dies corresponds to the maximum number of memory components, wait for one or more memory operations to be completed by an individual memory die of the first or second portions of the first or second plurality of memory dies.

In some examples, the controller can, in response to determining that the number of memory dies in the first portion of the first plurality of memory dies corresponds to the maximum number of memory components and that the number of memory dies in the second portion of the second plurality of memory dies corresponds to the maximum number of memory components, determine whether an additional group of memory dies on a different back-channel of the plurality of back-end channels includes fewer active memory dies than the maximum number of memory components. In such cases, the controller can distribute an additional portion of the plurality of memory operations to the additional group of memory dies in response to determining that the additional group of memory dies includes fewer active memory dies than the maximum number of memory components.

The set of memory components can be included as part of a memory sub-system including four groups of memory components on separate back-end channels, with each group of the four groups of memory components including eight memory dies. In some cases, a first pair of groups of the four groups of memory components includes a first stack and a second pair of groups of the four groups of memory components includes a second stack.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies).

In some examples, the memory sub-system 110 is a storage system. A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface, such as one or more front-end channels of the memory sub-system 110. Examples of a physical host interface include, but are not limited to, a serial advanced technology attachment (SATA) interface, a peripheral component interconnect express (PCIe) interface, a compute express link (CXL), a USB interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120. In some cases, a first host system 120 can be coupled to the memory sub-system 110 over a first front-end channel and a second host system 120 can be coupled to the memory sub-system 110 over a second front-end channel.

The memory components 112A to 112N can include any combination of the different types of non-volatile memory components and/or volatile memory components. An example of non-volatile memory components includes NAND-type flash memory. Each of the memory components 112A to 112N can include one or more arrays of memory cells such as single-level cells (SLCs) or multi-level cells (MLCs) (e.g., tri-level cells (TLCs) or quad-level cells (QLCs)). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages, word lines (WLs), WL groups (WGPs), planes, blocks, or sub-blocks that can refer to a unit of the memory component 112 used to store data. In general, the memory pages, WLs, WGPs, sub-blocks, and/or blocks are collectively or individually referred to as memory components.

A memory sub-system controller 115 can communicate with the memory components 112A to 112N to perform operations such as reading data, writing data, or erasing data at the memory components 112A to 112N and other such operations over one or more back-end channels. In some cases, a first portion (e.g., a first stack of memory dies) of the set of memory components 112A to 112N can be coupled to a first set of the one or more back-end channels and a second portion (e.g., a second stack of memory dies) of the set of memory components 112A to 112N can be coupled to a second set of the one or more back-end channels. In some cases, each stack of memory dies can be coupled to the memory sub-system controller 115 on a respective back-end channel. The memory sub-system controller 115 can communicate with the memory components 112A to 112N over the one or more back-end channels to perform various memory management operations, such as different scan rates, different scan frequencies, different wear leveling, different read disturb management operations, such as read disturb scan operations, different near miss ECC operations, folding operations, preventing folding operations from being performed, and/or different dynamic data refresh operations.

The memory sub-system controller 115 can include hardware such as one or more integrated circuits and/or discrete components, one or more thermometers (used to measure a current operating temperature of the memory sub-system 110 and/or the memory components 112A to 112N or ambient temperature), a buffer memory, and/or a combination thereof. In some examples, the output of the one or more thermometers can be used to determine a current write temperature to be stored in association with data on the memory components 112A to 112N.

The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include ROM for storing microcode. While the example memory sub-system 110 in FIG. 1 has been illustrated as including the memory sub-system controller 115, in another example, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands, requests, or operations from the host system 120 and can convert the commands, requests, or operations into instructions or appropriate commands to achieve the desired access to the memory components 112A to 112N. In some examples, the commands or operations received from the host system 120 can specify configuration data for the memory components 112A to 112N. The configuration data can include a table that specifies the WGPs or other grouping information for the data stored in the set of memory components 112A to 112N.

In some examples, the configuration data can include power management information. The power management information can specify a maximum number of memory dies or memory components 112A to 112N that can be active (e.g., performing read/write operations) at a given time. The power management information can specify, within a specific group (e.g., a set of memory dies coupled over a particular back-end channel to the memory sub-system controller 115) and/or memory die stack (that includes multiple groups coupled over different back-end channels to the memory sub-system controller 115), the maximum number of allowable individual memory dies or memory components 112A to 112N that can be active simultaneously. The power management information can also specify routing or distribution methods, operations, strategies, or requirements for the memory sub-system controller 115 to follow in balancing power across the different groups and/or stacks, as discussed below.

The memory sub-system controller 115 can be responsible for other memory management operations, such as wear leveling operations, garbage collection operations, error detection and ECC operations, encryption operations, caching operations, media scans (where different block stripes are read and analyzed for errors to determine whether to refresh or fold the block stripe), data refreshing, read disturb operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which are raw memory devices combined with local embedded controllers (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), communicate with the memory sub-system controller 115, and execute memory requests (e.g., read or write) received from the memory sub-system controller 115.

The memory sub-system controller 115 can include a media operations manager 122. The media operations manager 122 can be configured to provide adaptive power management. The media operations manager 122 receives one or more requests to perform a plurality of memory operations associated with data stored in the set of memory components 112A to 112N. The media operations manager 122, in response to receiving the one or more requests, accesses power management information associated with the set of memory components 112A to 112N. The media operations manager 122 determines, based on the power management information, a maximum number of memory components, in each group of a plurality of groups of the set of memory components 112A to 112N, that are configured to be simultaneously enabled for performing one or more memory operations. The media operations manager 122 distributes the plurality of memory operations across the plurality of groups based on the maximum number of memory components 112A to 112N that are configured to be simultaneously enabled for performing the one or more memory operations.

Depending on the examples, the media operations manager 122 can comprise logic (e.g., a set of transitory or non-transitory machine instructions, such as firmware) or one or more components that cause the media operations manager 122 to perform operations described herein. The media operations manager 122 can comprise a tangible or non-tangible unit capable of performing operations described herein. Further details with regard to the operations of the media operations manager 122 are described below.

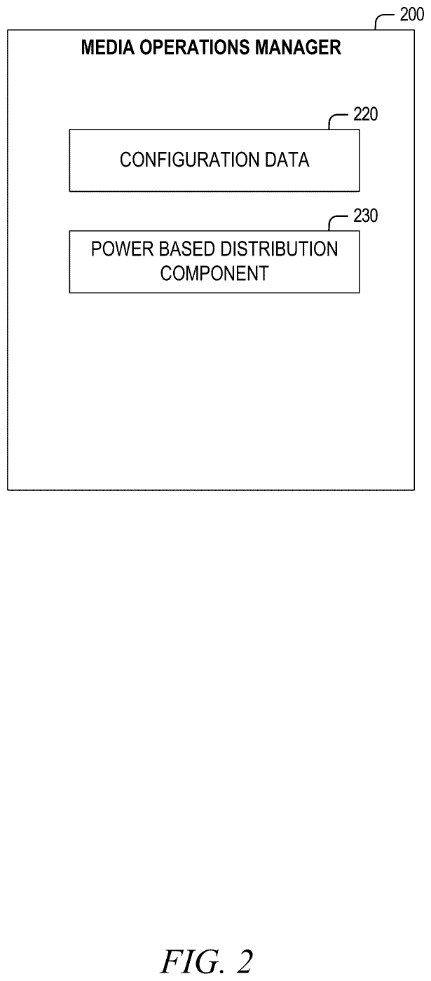

FIG. 2 is a block diagram of an example media operations manager 200 (corresponding to media operations manager 122), in accordance with some examples. As illustrated, the media operations manager 200 includes configuration data 220 and a power-based distribution component 230. For some examples, the media operations manager 122 can differ in components or arrangement (e.g., less or fewer components) from what is illustrated in FIG. 2.

The configuration data 220 accesses and/or stores configuration data associated with the memory components 112A to 112N. In some examples, the configuration data 220 is programmed into the media operations manager 122. For example, the media operations manager 122 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including the WGPs, different bins, groups, blocks, WLs, memory dies, and/or sets of the memory components 112A to 112N. The media operations manager 122 receives the configuration data from the host system 120 and stores the configuration data in the configuration data 220. The configuration data configuration data 220 can include power management information that is used by the power-based distribution component 230 to balance power usage across various groups/stacks of memory dies (e.g., the set of memory components 112A to 112N).

In some examples, the power-based distribution component 230 receives a plurality of requests from the host system 120. For example, the power-based distribution component 230 can receive a set of requests to program data and/or a set of requests to read data from the set of memory components 112A to 112N. In response, the power-based distribution component 230 can translate logic addresses in the requests to physical addresses of the set of memory components 112A to 112N. In some cases, this translation can be performed based on power management information stored in the configuration data 220.

For example, the power-based distribution component 230 can generate a set of memory operation commands based on the set of requests. The power-based distribution component 230 can then distribute the set of commands to the set of memory components 112A to 112N in a way that balances and maximizes the amount of power that is allowed to be used by the set of memory components 112A to 112N at any given time. For example, the power management information can specify that within each group (e.g., a stack of memory dies), only eight memory components (e.g., memory dies) can be active simultaneously. To maximize the amount of power and balance power usage by the memory commands, the power-based distribution component 230 can distribute or cause a first portion of the set of memory operation commands to be performed by the maximum number of memory components (e.g., eight memory dies) within a first group or stack simultaneously with causing a second portion of the set of memory operation commands to be performed by the maximum number of memory components (e.g., eight memory dies) within a second group or stack. In this way, sixteen memory dies can be active at a given time simultaneously, which increases throughput and improves the overall efficiencies of operating the memory sub-system 110.

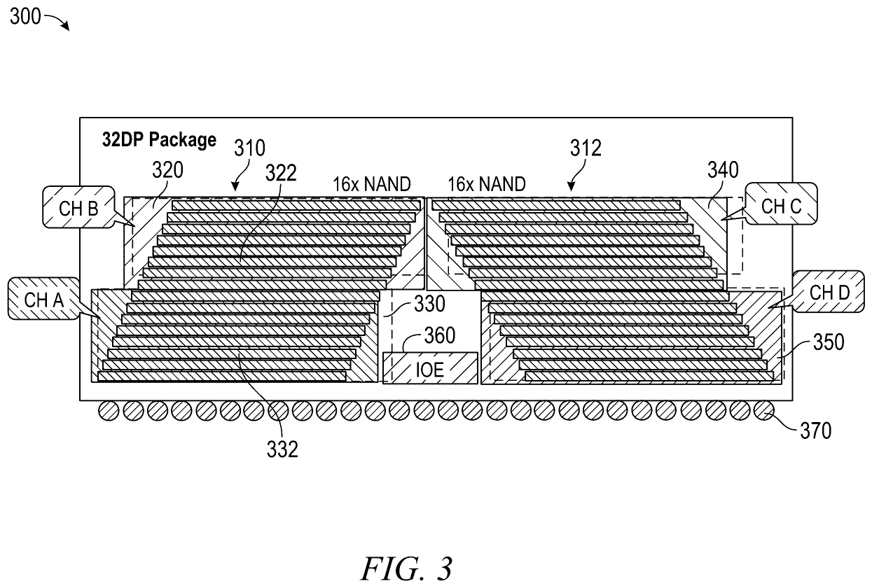

Specifically, as shown in the diagram 300 of FIG. 3, an example memory sub-system 110 can include a total of 32 memory dies. It should be understood that this is only one example, and any number of additional memory dies and/or channels can be similarly provided and used to distribute memory operation commands. The memory sub-system 110 shown in the diagram 300 can include an input-output expander 360, which can implement some or all of the functionalities of the memory sub-system controller 115. The input-output expander 360 can be coupled to the host system 120 via one or more physical pins 370 that form one or more front-end channels. The input-output expander 360 can be coupled to different groups and/or stacks of memory dies via respective back-end channels.

For example, the memory sub-system 110 shown in the diagram 300 can include a first stack of memory components 310 and a second stack of memory components 312. The first stack of memory components 310 can include sixteen memory dies. For example, the first stack of memory components 310 can include a first group of memory dies 320 (e.g., eight memory dies) and a second group of memory dies 330 (e.g., eight memory dies). The first group of memory dies 320 can include a first plurality of memory dies 322 or individual memory components and the second group of memory dies 330 can include a second plurality of memory dies 332. Similarly, the second stack of memory components 312 includes a third group of memory dies 340 and a fourth group of memory dies 350. In some cases, the first group of memory dies 320 is coupled to the input-output expander 360 via a first back-end channel, the second group of memory dies 330 is coupled to the input-output expander 360 via a second back-end channel, the third group of memory dies 340 is coupled to the input-output expander 360 via a third back-end channel, and the fourth group of memory dies 350 is coupled to the input-output expander 360 via a fourth back-end channel.

In some cases, the input-output expander 360 can selectively and dynamically distribute memory operation commands to different ones of the groups and/or stacks in a way that balances power usage and maximizes the number of simultaneous memory operations that can be performed. The input-output expander 360 can distribute the memory operations in a way that maximizes the number of memory dies or components that are active at any given time without violating restrictions or conditions specified by the power management information provided by the configuration data 220 (e.g., without activating more than the maximum number of eight memory dies that can be active within a particular group or stack at a given time).

For example, the power management information can include instructions to route a set of memory commands to one group or stack of memory components up to the maximum number of memory components that can be active at a given time within the group before routing additional memory commands to another group or stack of memory components. In such circumstances, the input-output expander 360 routes a first set of memory operation commands to the second group of memory dies 330 and continues routing memory operations commands to the second group of memory dies 330 until the maximum number of allowable memory components that can be active at a given time is reached (e.g., until a total of eight memory components of the 16 memory components in the first stack of memory components 310 is reached). At that point, the input-output expander 360 routes a second set of memory operation commands to the fourth group of memory dies 350 and continues routing memory operations commands to the fourth group of memory dies 350 until the maximum number of allowable memory components that can be active at a given time is reached (e.g., until a total of eight memory components of the 16 memory components in the second stack of memory components 312 is reached).

The input-output expander 360 can determine that the maximum number of memory components in the second stack of memory components 312 has been reached. In response, the input-output expander 360 starts routing further memory operation commands back to the first stack of memory components 310 when one or more memory components to which the memory commands were previously routed completes performing the memory operations. For example, the input-output expander 360 can route a third set of memory operation commands to the first group of memory dies 320 and continue routing memory operations commands to the first group of memory dies 320 until the maximum number of allowable memory components that can be active at a given time is reached (e.g., until a total of eight memory components of the 16 memory components in the first stack of memory components 310 is reached).

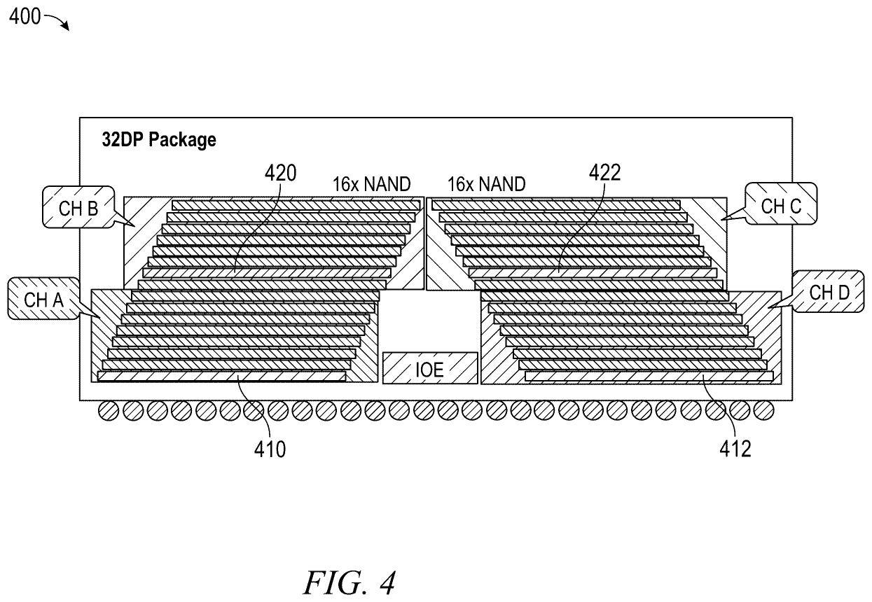

In some examples, the power management information can include instructions to interleave routing sets of memory commands between different groups or stacks of memory components up to the maximum number of memory components that can be active at a given time. For example, as shown in the diagram 400 of FIG. 4 (which represents similar architecture of the memory sub-system 110 shown in the diagram 300), the input-output expander 360 routes a first set of commands to the second group of memory dies 330 (e.g., over a first back-end channel), such as to a first group of memory dies 410. Prior to reaching the maximum number of memory dies in the second group of memory dies 330, the input-output expander 360 routes a second set of commands to the fourth group of memory dies 350 (e.g., over a second back-end channel), such as to a second group of memory dies 412. The input-output expander 360 can continue interleaving the distribution of the memory commands in this manner, alternating between routing commands to the second group of memory dies 330 and routing commands to the fourth group of memory dies 350, until the maximum number of memory components that can be active within the second group of memory dies 330 and the fourth group of memory dies 350 is reached.

In response to determining that the maximum number of memory components that can be active within the second group of memory dies 330 and the fourth group of memory dies 350 has been reached, the input-output expander 360 waits before sending additional memory operations commands to the first stack of memory components 310 or second stack of memory components 312. When the input-output expander 360 determines that one or more memory dies completed performing operations and that fewer than the maximum number of memory components that can be active are currently active, the input-output expander 360 begins routing further memory commands to memory dies 420 and 422 in the first and second groups of memory dies 320 and 350 over respective back-end channels.

In some cases, the power management information can include instructions to interleave routing sets of memory commands between different groups of memory dies within the same stack of memory components up to the maximum number of memory components that can be active at a given time. For example, the input-output expander 360 routes a first set of commands to the second group of memory dies 330 (e.g., over a first back-end channel), such as to a first group of memory dies 410. Prior to reaching the maximum number of memory dies in the second group of memory dies 330, the input-output expander 360 routes a second set of commands to the first group of memory dies 320 (e.g., over a second back-end channel) within the same first stack of memory components 310. The input-output expander 360 can continue interleaving the distribution of the memory commands in this manner, alternating between routing commands to the second group of memory dies 330 and routing commands to the first group of memory dies 320, until the maximum number of memory components that can be active within the second group of memory dies 330 and the first group of memory dies 320 is reached.

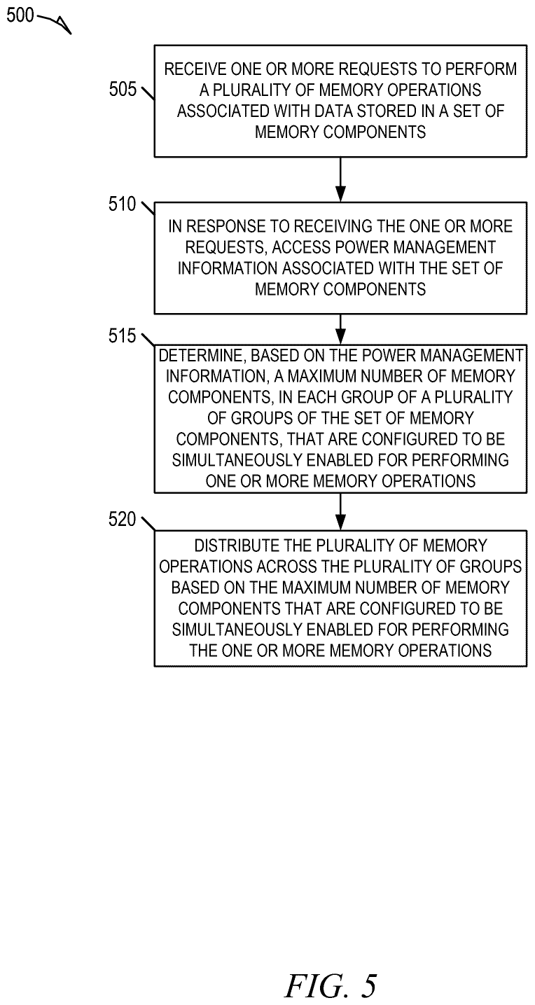

FIG. 5 is a flow diagram of an example method 500 to perform media management operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 505 where the media operations manager 200 (e.g., the firmware of the memory sub-system 110) receives one or more requests to perform a plurality of memory operations associated with data stored in a set of memory components. Then, at operation 510, the media operations manager 200, in response to receiving the one or more requests, accesses power management information associated with the set of memory components. At operation 515, the media operations manager 200, based on the power management information, a maximum number of memory components, in each group of a plurality of groups of the set of memory components, that are configured to be simultaneously enabled for performing one or more memory operations. At operation 520, the media operations manager 200 distributes the plurality of memory operations across the plurality of groups based on the maximum number of memory components that are configured to be simultaneously enabled for performing the one or more memory operations.

In view of the disclosure above, various examples are set forth below. It should be noted that one or more features of an example, taken in isolation or combination, should be considered within the disclosure of this application.

Example 1. A system comprising: a set of memory components; and a processing device operatively coupled to the set of memory components, the processing device being configured to perform operations comprising: receiving one or more requests to perform a plurality of memory operations associated with data stored in the set of memory components; in response to receiving the one or more requests, accessing power management information associated with the set of memory components; determining, based on the power management information, a maximum number of memory components, in each group of a plurality of groups of the set of memory components, that are configured to be simultaneously enabled for performing one or more memory operations; and distributing the plurality of memory operations across the plurality of groups based on the maximum number of memory components that are configured to be simultaneously enabled for performing the one or more memory operations.

Example 2. The system of Example 1, wherein the plurality of memory operations comprises at least one of one or more requests to program data or one or more requests to read data.

Example 3. The system of any one of Examples 1-2, wherein the set of memory components are part of a memory sub-system, the memory sub-system comprising one or more front-end channels and a plurality of back-end channels.

Example 4. The system of Example 3, wherein the one or more front-end channels are configured to receive the one or more requests from a host system, and wherein the plurality of back-end channels are configured to route commands generated based on the one or more requests to the set of memory components.

Example 5. The system of any one of Examples 3-4, wherein a first group of the plurality of groups of the set of memory components comprises a first plurality of memory dies coupled to a first channel of the plurality of back-end channels, and wherein a second group of the plurality of groups of the set of memory components comprises a second plurality of memory dies coupled to a second channel of the plurality of back-end channels.

Example 6. The system of Example 5, the operations comprising: routing a first portion of the plurality of memory operations to a first portion of the first plurality of memory dies; determining that a number of memory dies in the first portion of the first plurality of memory dies corresponds to the maximum number of memory components; and in response to determining that the number of memory dies in the first portion of the first plurality of memory dies corresponds to the maximum number of memory components, routing a second portion of the plurality of memory operations to a second portion of the second plurality of memory dies.

Example 7. The system of any one of Examples 5-6, the operations comprising: interleaving routing a first portion of the plurality of memory operations to a first portion of the first plurality of memory dies with routing a second portion of the plurality of memory operations to a second portion of the second plurality of memory dies.

Example 8. The system of Example 7, wherein the first plurality of memory dies are part of a first stack of memory dies, and wherein the second plurality of memory dies are part of a second stack of memory dies.

Example 9. The system of any one of Examples 7-8, the operations comprising: determining that a number of memory dies in the first portion of the first plurality of memory dies corresponds to the maximum number of memory components and that a number of memory dies in the second portion of the second plurality of memory dies corresponds to the maximum number of memory components.

Example 10. The system of Example 9, the operations comprising: in response to determining that the number of memory dies in the first portion of the first plurality of memory dies corresponds to the maximum number of memory components and that the number of memory dies in the second portion of the second plurality of memory dies corresponds to the maximum number of memory components, before routing additional memory operations to the set of memory components, waiting for one or more memory operations to be completed by an individual memory die of the first or second portions of the first or second plurality of memory dies.

Example 11. The system of any one of Examples 9-10, the operations comprising: in response to determining that the number of memory dies in the first portion of the first plurality of memory dies corresponds to the maximum number of memory components and that the number of memory dies in the second portion of the second plurality of memory dies corresponds to the maximum number of memory components, determining whether an additional group of memory dies on a different back-channel of the plurality of back-end channels includes fewer active memory dies than the maximum number of memory components.

Example 12. The system of Example 11, the operations comprising: distributing an additional portion of the plurality of memory operations to the additional group of memory dies in response to determining that the additional group of memory dies includes fewer active memory dies than the maximum number of memory components.

Example 13. The system of any one of Examples 1-12, wherein the set of memory components are included as part of a memory sub-system comprising four groups of memory components on separate back-end channels, each group of the four groups of memory components comprising eight memory dies.

Example 14. The system of Example 13, wherein a first pair of groups of the four groups of memory components comprise a first stack, and wherein a second pair of groups of the four groups of memory components comprises a second stack.

Methods and computer-readable storage medium with instructions for performing any one of the above Examples.

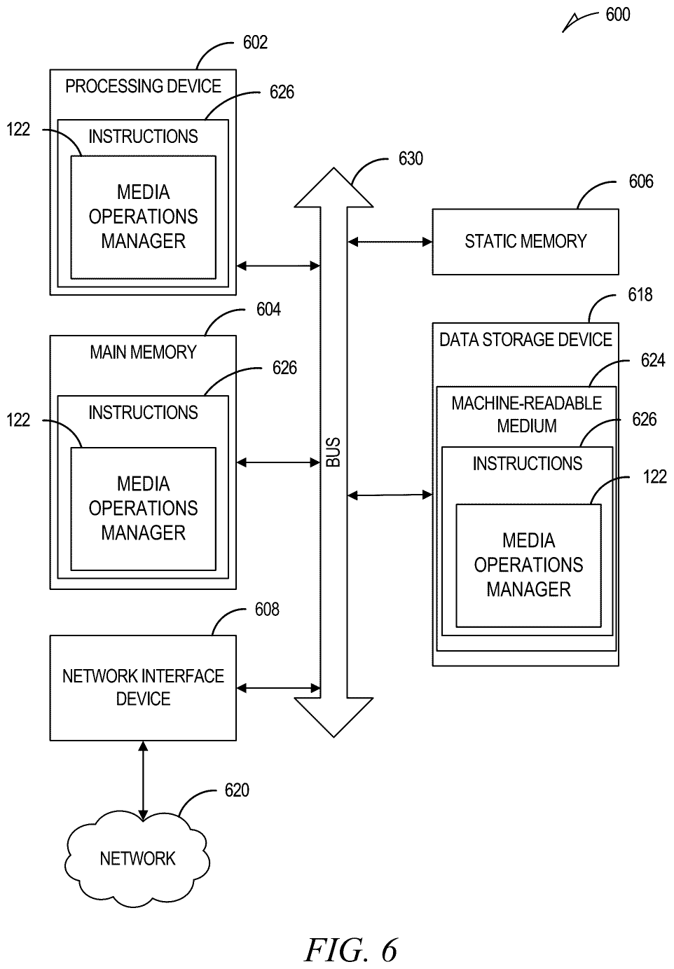

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an ASIC, a FPGA, a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one example, the instructions 626 implement functionality corresponding to the media operations manager 122 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; ROMs; RAMs; erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as ROM, RAM, magnetic disk storage media, optical storage media, flash memory components, and so forth.

In the foregoing specification, examples of the disclosure have been described with reference to specific example embodiments thereof. It will be evident that various modifications can be made thereto without departing from the broader examples of the disclosure as set forth in the following claims. The specification and drawings are, accordingly, to be regarded in an illustrative sense rather than a restrictive sense.

What is claimed is:

1. A system comprising:
a set of memory components; and
a processing device operatively coupled to the set of memory components, the processing device being configured to perform operations comprising:
receiving one or more requests to perform a plurality of memory operations associated with data stored in the set of memory components;
in response to receiving the one or more requests, accessing power management information associated with the set of memory components;
determining, based on the power management information, a maximum number of memory components, in each group of a plurality of groups of the set of memory components, that are configured to be simultaneously enabled for performing one or more memory operations; and
distributing the plurality of memory operations across the plurality of groups based on the maximum number of memory components that are configured to be simultaneously enabled for performing the one or more memory operations.

2. The system of claim 1, wherein the plurality of memory operations comprises at least one of one or more requests to program data or one or more requests to read data.

3. The system of claim 1, wherein the set of memory components are part of a memory sub-system, the memory sub-system comprising one or more front-end channels and a plurality of back-end channels.

4. The system of claim 3, wherein the one or more front-end channels are configured to receive the one or more requests from a host system; and
wherein the plurality of back-end channels are configured to route commands generated based on the one or more requests to the set of memory components.

5. The system of claim 3, wherein a first group of the plurality of groups of the set of memory components comprises a first plurality of memory dies coupled to a first channel of the plurality of back-end channels; and
wherein a second group of the plurality of groups of the set of memory components comprises a second plurality of memory dies coupled to a second channel of the plurality of back-end channels.

6. The system of claim 5, the operations comprising:
routing a first portion of the plurality of memory operations to a first portion of the first plurality of memory dies;
determining that a number of memory dies in the first portion of the first plurality of memory dies corresponds to the maximum number of memory components; and
in response to determining that the number of memory dies in the first portion of the first plurality of memory dies corresponds to the maximum number of memory components, routing a second portion of the plurality of memory operations to a second portion of the second plurality of memory dies.

7. The system of claim 5, the operations comprising:
interleaving routing a first portion of the plurality of memory operations to a first portion of the first plurality of memory dies with routing a second portion of the plurality of memory operations to a second portion of the second plurality of memory dies.

8. The system of claim 7, wherein the first plurality of memory dies are part of a first stack of memory dies; and
wherein the second plurality of memory dies are part of a second stack of memory dies.

9. The system of claim 7, the operations comprising:
determining that a number of memory dies in the first portion of the first plurality of memory dies corresponds to the maximum number of memory components and that a number of memory dies in the second portion of the second plurality of memory dies corresponds to the maximum number of memory components.

10. The system of claim 9, the operations comprising:
in response to determining that the number of memory dies in the first portion of the first plurality of memory dies corresponds to the maximum number of memory components and that the number of memory dies in the second portion of the second plurality of memory dies corresponds to the maximum number of memory components, before routing additional memory operations to the set of memory components, waiting for one or more memory operations to be completed by an individual memory die of the first or second portions of the first or second plurality of memory dies.

11. The system of claim 9, the operations comprising:
in response to determining that the number of memory dies in the first portion of the first plurality of memory dies corresponds to the maximum number of memory components and that the number of memory dies in the second portion of the second plurality of memory dies corresponds to the maximum number of memory components, determining whether an additional group of memory dies on a different back-channel of the plurality of back-end channels includes fewer active memory dies than the maximum number of memory components.

12. The system of claim 11, the operations comprising:
distributing an additional portion of the plurality of memory operations to the additional group of memory dies in response to determining that the additional group of memory dies includes fewer active memory dies than the maximum number of memory components.

13. The system of claim 1, wherein the set of memory components are included as part of a memory sub-system comprising four groups of memory components on separate back-end channels, each group of the four groups of memory components comprising eight memory dies.

14. The system of claim 13, wherein a first pair of groups of the four groups of memory components comprise a first stack; and
wherein a second pair of groups of the four groups of memory components comprises a second stack.

15. A method comprising:
receiving one or more requests to perform a plurality of memory operations associated with data stored in a set of memory components;
in response to receiving the one or more requests, accessing power management information associated with the set of memory components;
determining, based on the power management information, a maximum number of memory components, in each group of a plurality of groups of the set of memory components, that are configured to be simultaneously enabled for performing one or more memory operations; and
distributing the plurality of memory operations across the plurality of groups based on the maximum number of memory components that are configured to be simultaneously enabled for performing the one or more memory operations.

16. The method of claim 15, wherein the plurality of memory operations comprises at least one of one or more requests to program data or one or more requests to read data.

17. The method of claim 15, wherein the set of memory components are part of a memory sub-system, the memory sub-system comprising one or more front-end channels and a plurality of back-end channels.

18. The method of claim 17, wherein the one or more front-end channels are configured to receive the one or more requests from a host system; and
wherein the plurality of back-end channels are configured to route commands generated based on the one or more requests to the set of memory components.

19. The method of claim 17, wherein a first group of the plurality of groups of the set of memory components comprises a first plurality of memory dies coupled to a first channel of the plurality of back-end channels; and
wherein a second group of the plurality of groups of the set of memory components comprises a second plurality of memory dies coupled to a second channel of the plurality of back-end channels.

20. A non-transitory computer-readable storage medium comprising instructions that, when executed by a processing device, cause the processing device to perform operations comprising:
receiving one or more requests to perform a plurality of memory operations associated with data stored in a set of memory components;
in response to receiving the one or more requests, accessing power management information associated with the set of memory components;
determining, based on the power management information, a maximum number of memory components, in each group of a plurality of groups of the set of memory components, that are configured to be simultaneously enabled for performing one or more memory operations; and
distributing the plurality of memory operations across the plurality of groups based on the maximum number of memory components that are configured to be simultaneously enabled for performing the one or more memory operations.
